(19) United States
(12) Patent Application Publication
(10) Pub. No.: US 2010/0166269 A1
(43) Pub. Date: Jul. 1, 2010

(54) AUTOMATIC BODY SILHOUETTE MATCHING FOR REMOTE AUSCULTATION

(76) Inventors: Beth Logan, Cambridge, MA (US); Jean-Manuel Van Thong, Arlington, MA (US); Rahul Sukthankar, Orlando, FL (US); Frank Bomba, Boston, MA (US)

Correspondence Address: INTEL CORPORATION;c/o CPA Global, P.O. BOX 52050, MINNEAPOLIS, MN, 55402, US

(21) Appl. No.: 12/347,861

(22) Filed: Dec. 31, 2008

(51) Int. Cl. G06K 9/62; G06K 9/00

(52) U.S. Cl. 382/128; 382/209

(57) ABSTRACT

A system provides a means to detect and track a patient silhouette which may be used to instruct him/her in positioning a medical sensing device on his/her chest with guidance from a computer or from a remotely located physician. The medical sensing device may be, for example a stethoscope or other device.

### FIELD OF THE INVENTION

Embodiments of the present invention are directed to remote care systems (telemedicine systems) and, more particularly, to a system guide the placement of medical device on the body by a patient automatically, or with the help of a remote physician.

### BACKGROUND INFORMATION

Routine and on going healthcare practices usually require a trip to the doctor's office or hospital. Long gone are the days when doctors made house calls. As the population ages, and as medical costs skyrocket, technological solutions have emerged in the form of home-based health care services and telemedicine services. Home based healthcare may be advantageous not only from an economic standpoint but, as a practical matter, many people and particularly those with chronic illnesses requiring frequent monitoring may prefer to stay at home and receive appropriate medical care.

Typically home health care visits are made by a registered nurse, nurse assistant or some type of therapist. This may also be costly since it requires a paid professional's time to travel to the patient's home and then perform the necessary medical services.

Many remote monitoring systems exist which monitor a patient's vitals, such as heart rate or blood glucose levels and relay them to a doctor. Such systems are fine since no real time professional involvement may be needed. On occasions when some interaction between patient and doctor are desired, telecommunications technologies, and particularly video-conferencing, may offer an opportunity to provide cost effective home health care. While video conferencing may improve home health care it unfortunately lacks any hands-on ability for the doctor to perform routine tasks such as listening to a heartbeat or respiratory sounds.

### BRIEF DESCRIPTION OF THE DRAWINGS

The foregoing and a better understanding of the present invention may become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and the invention is not limited thereto.

FIG. 1 is a computer system to guide a patient in the proper placement of a medical device, such as a stethoscope, according to one embodiment;

FIG. 2 is a diagram illustrating mapping a patient silhouette to a template silhouette having predefined stethoscope locations marked; and

FIG. 3 is an X-Y plotter device for automatic placement the stethoscope according to one embodiment.

### DETAILED DESCRIPTION

Described is a system that provides a means to detect and track a patient silhouette which will be used to instruct him/her in positioning a medical sensing device on his/her chest with guidance from a computer or from a remotely located physician. The medical sensing device may be, for example a stethoscope or other device. New stethoscope technology allows decoupling the acoustic sensor from the headset, allowing remote auscultation. The patient may interact with just the system or may interact with a physician or other medical professional and communicate via a console comprising of one or more cameras, a computer screen with a user interface, a microphone and speakers, for example.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

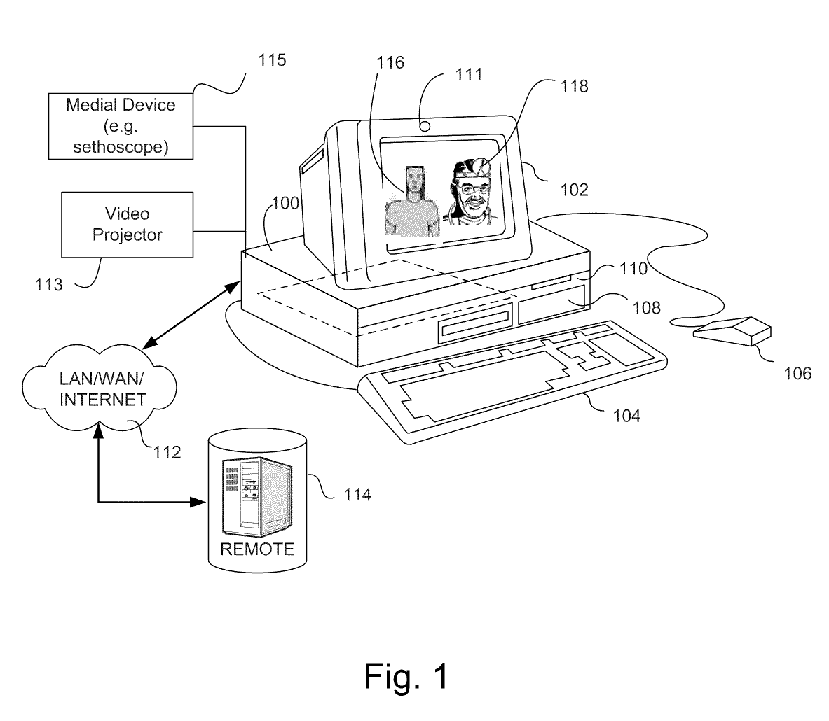

Referring now to FIG. 1, there is shown a computer 100 with which a patient may be situated near. A desk-top computer is shown, but embodiments are not limited thereto as laptop or other portable devices may be used. The computer 100 may include a display screen 102, which may be a touch screen, a keyboard 104, a mouse 106, speakers 108, a microphone 110, a camera 111, and any other peripheral, such as a video projector 113 or medial device 115. The computer may be connected to a network, such as the Internet 112 in communication with a remote device 114 where a doctor or other medical professional may be located.

The patient faces the camera 111 and a computer screen 102 which may display his own image 116 (similar to a mirror), and possibly the image of a remote doctor 118. In addition to the video display, the screen may display a user interface which enables visual instructions to be given to the patient. It may also capture feedback, for example via a touch screen. In other embodiments, some or all of the instructions to the patient may be via a voice recording or speech synthesis or given by the doctor if connected.

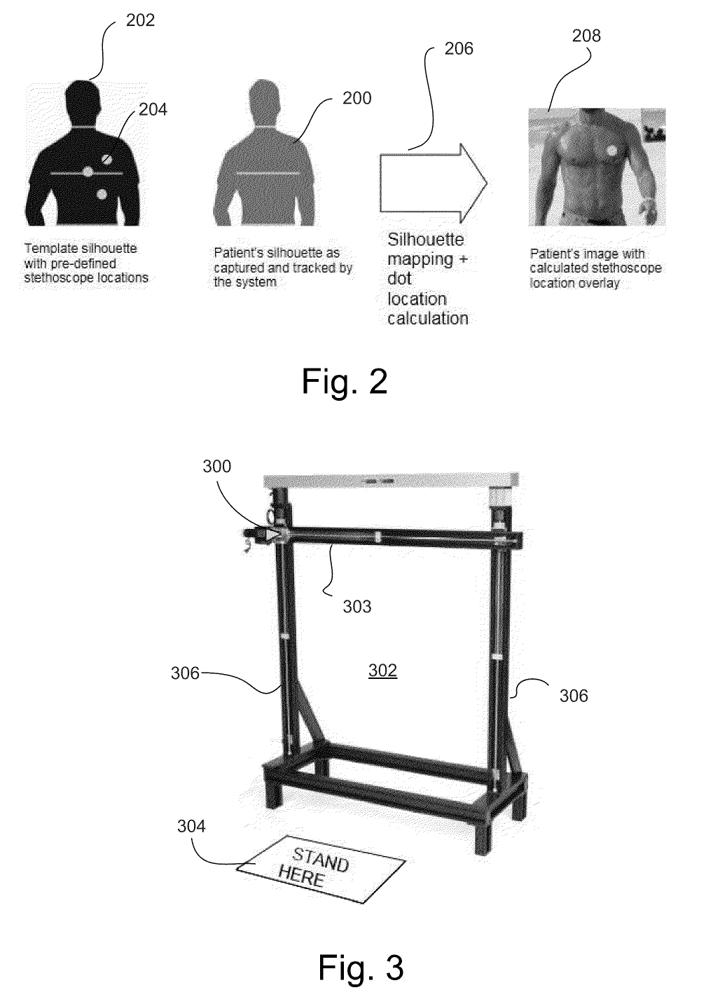

As shown in FIG. 2, the system extracts the silhouette of the patient 200, and matches it to a predefined 2D silhouette template 202. The system may have templates for a variety of human morphologies on which locations for stethoscope placement 204 have been pre-determined, and the duration for which to apply it in each location.

To extract the silhouette, the patient may sit in front of a background with a solid color and the system computes a silhouette of the upper body (head and torso) from the image captured by the camera. This may be referred the target silhouette. Note that the target silhouette can be computed and updated on the fly as the patient moves while sitting in front of the camera. Given a known background, this silhouette can be efficiently computed using a variety of well-known image processing algorithms, such as image differencing.

For backgrounds of uniform color, standard chroma key (bluescreen) technology could be used to obtain the foreground image. Alternately, given multiple cameras, the system can intersect the silhouettes computed from each view to generate a 3D visual hull of the subject that can potentially be fitted to the known silhouette templates more accurately.

As noted above, the system has stored 2D silhouette templates 202 for a variety of human morphologies (e.g., male, female, child templates) on which locations 204 for a medical device's placement (e.g. a stethoscope or ECG patches) have been pre-determined, and the duration for which to apply it in each location. The best patient template can be selected from the patient's information (e.g., gender and age), or may be defined for different pathologies, or by the doctor for a given patient.

The system matches the patient's silhouette against the most appropriate patient template and transforms the desired device locations from the model to the target silhouette using a geometric transformation. The silhouette matching can be done using either global or piecewise deformations.

The resulting silhouette tracking system can be used by a physician to instruct the patient to position a medical device on the body. An automated or semi-automated system displays visual feedback to the patient indicating specific body locations for positioning the device.

An optimization to the system may include improving the contrast of the patient with the background in order to better detect the target silhouette. From the image of the patient, the system detects if the skin is dark or light, and adjusts the background lightning accordingly. Patient silhouette acquisition can also be facilitated by illuminating the scene with an infrared source and observing the shape of the (infrared) shadow cast by the patient on the background using an appropriately-placed camera.

The system may be calibrated by using visual marks (e.g., cross hatch) on a fixed background so the position of the patient relative to the background and the positioning devices can be determined at any point in time. The system then calculates and maps the appropriate location for placing the stethoscope or other device on the patient from the silhouette template 206 and overlays a dot, or another meaningful icon, on the video image of the patient (208 or 116) to indicate where to place the stethoscope. Alternatively, the system may project a dot directly on the patient's body at the appropriate location using a standard video projector 113. The patient then may place the stethoscope on his/her body by aligning it with the dot on the screen, or on the dot projected on his/her body.

The system may confirm correct placement of the sensor by tracking the location of the stethoscope chestpiece. This visual tracking can be facilitated by adding a distinctive visual marker or LEDs on the visible portion of the chestpiece. An acoustic or visual signal can indicate to the patient he/she has reached the requested correct placement.

Alternatively, referring to FIG. 3, the stethoscope 300 or other device may be placed on an X-Y wall device 302, similar to an X-Y plotter which may be controlled by the computer 100. Here, however, the X-Y plotter may be vertical. A boxed area delineated on the floor 304 indicates where the patient should stand. In this case, the sensor 300 (e.g. a stethoscope) is mounted on a bar 303 which is vertically-mounted tracks 306 to move anywhere in the X-Y plane by servo control. In an alternate embodiment, the patient may sit in a special chair which, similar to the wall device, with the stethoscope mounted on the seat back whose X-Y position can by controlled by the system.

After proper servo positioning, the patient is then requested to stand close to the wall device 302 at the predefined location or to sit in the chair and press his/her body gently against the sensor 300 (the sensor 300 may be spring-loaded for comfort.) Notably, having a stethoscope mounted on a wall or a chair is particularly useful perform auscultation on the patient's back which would be difficult to do by the patient manually.

In the X-Y system positioning method, correct placement may be assumed if the patient can be visually confirmed to be standing or sitting in place. Pressure pads on the floor or chair seat could additionally be used to confirm the placement. The presence of a reasonable acoustic signal (e.g. heartbeat is detectable) could additionally be used in any of the techniques to determine if the reading is taking place.

Once the system detects that the measurement has started, it displays a countdown on the screen to indicate to the patient how much time she should hold the stethoscope in place or stand near the wall or sit in the chair. Alternatively, the patient may press a button or key on the keyboard 104 to indicate that the stethoscope is in place in order to start the reading. The system can optionally analyze the acquired audio to confirm that the recording is of sufficient quality and that the chestpiece is in correct contact with the patient. If the audio is of insufficient quality, the patient is prompted with further instructions, for example to hold the chestpiece differently or move it to a different location. These alternate chest locations can be pre-programmed to handle situations where the audio signal quality is poor. Optionally the system may also display breathing instructions to the patient.

Once the measurement time is elapsed, the system iterates through the above steps until all recordings are completed for various locations on the patients body. The recorded data may be relayed to the remote location 114 for the doctor to read.

In an alternate embodiment, if the physician and the patient are in a video call, the physician may point using a digital pointing device which displays a dot or another meaningful icon at the location on the template torso, or projects it directly on the image of the patient, to describe where to put the stethoscope. In this case the physician may listen to the output of the stethoscope in real time and decide where to do the next measurement, just as if the patient was in the doctor's office.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a plurality of silhouette templates having predefined placement locations marked for placing a medical device;
a camera for capturing the image of a patient;
means for selecting an appropriate one of the plurality of silhouette templates that best matches the image of the patient; and
means for mapping the predefined placement locations from the selected silhouette template to the patient.

2. The apparatus as recited in claim 1 wherein the means for selecting comprises a computer.

3. The apparatus as recited in claim 1 wherein the means from mapping comprises a dot displayed on the image of the patient on a computer display screen.

4. The apparatus as recited in claim 1, further comprising:
a vertical X-Y plotter to be positioned relative to the patient; and
wherein the means for mapping comprises a computer controlling the position of the X-Y plotter.

5. The apparatus as recited in claim 4 further comprising:
a stethoscope movable with the X-Y plotter.

6. The apparatus as recited in claim 1, further comprising:
means to communicate over a network with a remotely located medical professional.

7. The apparatus as recited in claim 1, wherein the means from mapping comprises a computer controlled video projector to project a dot onto the patient.

8. A method, comprising:
storing a plurality of silhouette templates with at least one predefined medical device placement location;
capturing an image of a patient;
matching the image of the patient to an appropriate silhouette template; and
mapping the predefined medical device placement location to the patient.

9. The method as recited in claim 8 where in the medical device comprises a stethoscope.

10. The method as recited in claim 9, wherein the mapping comprises:
displaying a dot on the image of the patient on a display screen.

11. The method as recited in claim 9 wherein the mapping comprises:
projecting a light dot directly onto the patient.

12. The method as recited in claim 9 wherein the mapping comprises:
moving the stethoscope on a vertical X-Y plotter relative to the patient.

13. The method as recited in claim 9 further comprising:
indicating to the patient when proper placement of the stethoscope has been achieved.

14. The method as recited in claim 13 further comprising:
indicating to the patient the duration the stethoscope should remain in that placement.

15. The method as recited in claim 9 further comprising:
sending stethoscope data to a remotely located medical professional.

16. A system, comprising:
a plurality of silhouette templates having at least one predefined placement location marked for placing a stethoscope;
a camera for capturing the image of a patient;
a computer to map the predefined placement location from one of the silhouette templates to the patient.

17. The system as recited in claim 16 further comprising:
a video projector controlled by the computer to display a dot indicating the predefined placement location directly onto the patient.

18. The system as recited in claim 16, further comprising:
a computer display screen displaying a dot on the image of the patient indicating the predefined placement location.

19. The system as recited in claim 16, further comprising:
an X-Y plotter controlled by the computer to move the stethoscope relative to the patient.

20. The system as recited in claim 16, further comprising:
a connection to a remote computer for communication with a medical professional.
